(19) United States
(12) Patent Application Publication
(10) Pub. No.: US 2002/0035542 A1
(43) Pub. Date: Mar. 21, 2002

(54) Transaction authentication system utilizing a key with integrated biometric sensor

(76) Inventors: David M. Tumey, San Antonio, TX (US); Tianning Xu, San Antonio, TX (US)

Correspondence Address: William H.Quirk, 5018 Newcastle Lane, San Antonio, TX, 78249, US

(21) Appl. No.: 09/952,097

(22) Filed: Sep. 12, 2001

Related U.S. Application Data
(60) Provisional application No. 60/232,923, filed on Sep. 15, 2000.

(51) Int. Cl. G06T 1/00; H04Q 1/00; H04B 1/00; H04B 3/00; G06F 7/00; G06T 7/00; G06F 7/04; H04Q 9/00; G06K 9/00; G06F 17/60; G08B 29/00; G05B 23/00; G08C 19/00; G05B 19/00

(52) U.S. Cl. 705/44; 340/5.83; 382/124

(57) ABSTRACT

A financial transaction authentication system utilizing non-invasive biometric verification which includes a first computer-based device having stored thereon encoded first human fingerprint data representative of an authorized human user, a control device with display and keyboard for enrolling said authorized human user in said first computer-based device, a second computer-based device connected to said first computer-based device via a communications network, a key-like device having embedded thereon an integrated circuit-based fingerprint sensor for real-time gathering of second human fingerprint data, a receptacle for said key-like device, a first and second mating electrical contact which connects said fingerprint sensor to said second computer-based device when said key-like device is inserted in said receptacle, and software resident within said second computer-based device for human user verification, which can include minutiae analysis, neural networks or other equivalent algorithms, for comparing said first human fingerprint data with said second human fingerprint data and producing an output signal therefrom for use in the verification of said human user. The apparatus further includes software which permits the secure authentication of said human users for use in completing automated or Internet-based financial transactions. Said authentication can be granted or denied based on whether or not said human user's fingerprint is verified by said fingerprint verification algorithms.

### RELATED APPLICATIONS

This Application is a continuation of Applicant's copending U.S. Provisional Patent Application(s) Ser. No. 60/232,923 filed Sep. 15, 2000. This Application claims domestic priority, under 35 U.S.C. § 119(e)(1), to the earliest filing date of Sep. 15, 2000.

### FIELD OF THE INVENTION

The present invention is generally directed to a method and apparatus for preventing fraudulent financial transactions and more particularly preventing fraudulent ATM, debit/credit card, telephone calling card and Internet transactions by identifying and verifying a human fingerprint of an authorized individual or individuals and producing an output signal indicative of recognition or non-recognition of said individual(s) for permitting or preventing said financial transactions.

### BACKGROUND OF THE INVENTION:

Financial transaction security and more particularly the prevention of fraud has always been of paramount importance to financial institutions and individuals alike. Automated means which provide easy access to cash or credit, an increasing number of financial transactions utilizing the Internet and an increasingly sophisticated criminal environment have made securing financial transactions far more difficult than at any other time in history. Law enforcement officials find themselves overwhelmed and unable to protect the institutions or the average citizen from the ever-increasing incidence of financial theft. It is becoming apparent that traditional technology for securing financial transactions such as touch-pads with personal identification numbers (PIN), magnetic card readers, ID cards with two-dimensional barcodes, smart cards and other such conventional techniques are becoming less effective in preventing fraudulent financial transactions. The problem is costing financial institutions, businesses and U.S. citizens, billions of dollars each year. In recent years, corporations and private individuals alike have attempted to answer this daunting challenge by introducing a number of improved security system upgrades, such as sophisticated networked video surveillance and biometric identification techniques (recognizing an individual based on a anatomical metric), however, although very promising, biometric security systems have yet to be actively commercialized either due to their complexity, invasiveness or high cost.

There exists many methods for preventing fraudulent financial transactions and in particular securing ATM, debit/credit card, telephone calling card and Internet transactions as described herein above. Similarly there exists many methods for the biometric identification of humans which includes facial image verification, voice recognition, iris scanning, retina imaging as well as fingerprint pattern matching.

Iris and retina identification systems are considered “invasive”, expensive and not practical for applications where limited computer memory storage is available. Voice recognition is somewhat less invasive, however it is cost prohibitive and can require excessive memory storage space for the various voice “templates” and sophisticated recognition algorithms. In addition, identification processing delays can be excessive and unacceptable for many applications.

Face recognition systems, although non-invasive with minimal processing delays, are generally too sensitive to lighting conditions and do not lend themselves well to outdoor applications where lighting varies considerably such as is encountered when utilized with a stand-alone ATM machine. Face recognition systems can be successfully implemented for this application, however, a number of installation considerations, requiring specialized construction, must be taken into account.

Fingerprint verification is a minimally invasive biometric technique capable of positively identifying an authorized individual. The prior references are abundant with biometric verification systems that have attempted to identify an individual based on a digitized human fingerprint. Four major problems that have been recognized implicitly or explicitly by many prior reference inventors is that (1) Fingerprint sensors although minimally invasive, are still more invasive than the standard technologies commonly used in most security systems produced commercially (in view of the fact that the user must touch a special sensor with a finger in order to trigger a verification event); (2) Fingerprints are typically associated with law enforcement and criminals and therefore have a stigma attached to them which makes the fingerprint biometric less desirable for general security applications; (3) Prior to recent advances in single integrated circuit capacitive and thermal sensor arrays, as described in further detail herein below, fingerprint scanners and their associated hardware were cost prohibitive for all but the most demanding security applications. Further, the size of the fingerprint sensor precluded the direct integration into a key-like device preventing development of a system which could be utilized by a human in a natural manner; and (4) The complexity of the fingerprint verification algorithms and the expense of the early microprocessors needed to implement them made such a verification system impractical.

In addition to the four major problems referenced herein above, an additional limitation of the fingerprint biometric approach described in the prior art relates to the requirement for a common fingerprint acquisition sensor that must be touched by each human user. Market research has revealed that many individuals are of the opinion touching such a sensor might cause transmission of disease. Lastly, the sensor which relies on obtaining a clear image of the fingerprint, can become dirty from excessive use or unusable due to vandalism In order to overcome these limitations, a fingerprint verification system utilizing a sensor embedded directly into a key-like device can be constructed enabling each user to retain their biometric sensor thus eliminating concerns with respect to cleanliness, excessive use and vandalism. In addition, the key-like device can be designed so that its use is non-invasive and transparent to the user thus eliminating the criminal stigma associated with this particular biometric. With recent advancements in chip-based fingerprint sensors and the improved performance of inexpensive single board computers, it has become possible to implement a practical and cost effective fingerprint verification system for use in preventing fraudulent financial transactions.

Although many inventors have offered myriad approaches attempting to provide inexpensive, minimally invasive, and compact fingerprint verification systems in which fingerprints of human users could be stored, retrieved and compared at some later time to verify that a human user is indeed a properly authorized user, none have succeeded in producing a system that is practical and desirable for use in providing non-invasive biometric security for financial transactions. Because of these and other significant limitations, no commercially viable biometric system for ATMs and the like has been successfully marketed.

The present invention overcomes all of the aforesaid limitations by combining new inexpensive capacitive or electric field-based single integrated circuit fingerprint sensors, with streamlined verification algorithms and advanced microprocessor architectures. The most novel aspect of the present invention, which provides biometric verification completely transparent to the user, is the integration of the fingerprint sensor directly into a key-like device which includes features resembling an electronic card-key. The sensor is embedded in a grip area made of suitable material and arranged so as to be in intimate contact with the thumb or forefinger of a human user while the key is being held in a normal fashion. Thus a fingerprint can be acquired during routine use of the key without requiring an attentive action by the human user and is therefore totally non-invasive. In addition, the algorithms of the present invention have been optimized to run quickly on small inexpensive single board computers.

### SUMMARY OF THE INVENTION

It is an object of the present invention to improve the apparatus and method for acquiring fingerprint data from a human user in a non-invasive way.

It is another object of the present invention to improve the apparatus and method for preventing fraud in financial transactions and in particular automated and Internet based financial transactions.

Accordingly, one embodiment of the present invention is directed to a method and apparatus for a financial transaction authentication system utilizing non-invasive biometric verification which includes a first computer-based device having stored thereon encoded first human fingerprint data representative of an authorized human user, a control device with display and keyboard for enrolling said authorized human user in said first computer-based device, a second computer-based device connected to said first computer-based device via a communications network, a key-like device having embedded thereon an integrated circuit-based fingerprint sensor for real-time gathering of second human fingerprint data, a receptacle for said key-like device, a first and second mating electrical contact which connects said fingerprint sensor to said second computer-based device when said key-like device is inserted in said receptacle, and software resident within said second computer-based device for human user verification, which can include minutiae analysis, neural networks or other equivalent algorithms, for comparing said first human fingerprint data with said second human fingerprint data and producing an output signal therefrom for use in the verification of said human user. The apparatus further includes software which permits the secure authentication of said human users for use in completing automated or Internet-based financial transactions. Said authentication can be granted or denied based on whether or not said human user's fingerprint is verified by said fingerprint verification algorithms.

Other objects and advantages will be readily apparent to those of ordinary skill in the art upon viewing the drawings and reading the detailed description hereinafter.

### BRIEF DESCRIPTION OF THE DRAWINGS

FIG. 1 shows a block diagram of an aspect of the present invention for securing financial transactions and more particularly providing authentication for automated and Internet-based financial transactions.

FIG. 2 shows in functional block diagram a representation of minutiae analysis of the present invention.

FIG. 3 shows in functional block diagram a representation of a neural network of the present invention.

### DETAILED DESCRIPTION OF THE PREFERRED EMBODIMENT

Although those of ordinary skill in the art will readily recognize many alternative embodiments, especially in light of the illustrations provided herein, this detailed description is of the preferred embodiment of the present invention, a method and apparatus for authenticating financial transactions and more particularly preventing fraudulent ATM, debit/credit card, telephone calling card and Internet transactions.

Referring to the drawings, an apparatus for preventing fraud in financial transactions is generally referred to by the numeral 100. The apparatus 100 generally comprises a central administrative control center 101, a communications network which includes the Internet 102, a local computer with associated processing elements and interface electronics 103, and a key-like device with integrated fingerprint sensor and associated receptacle 104.

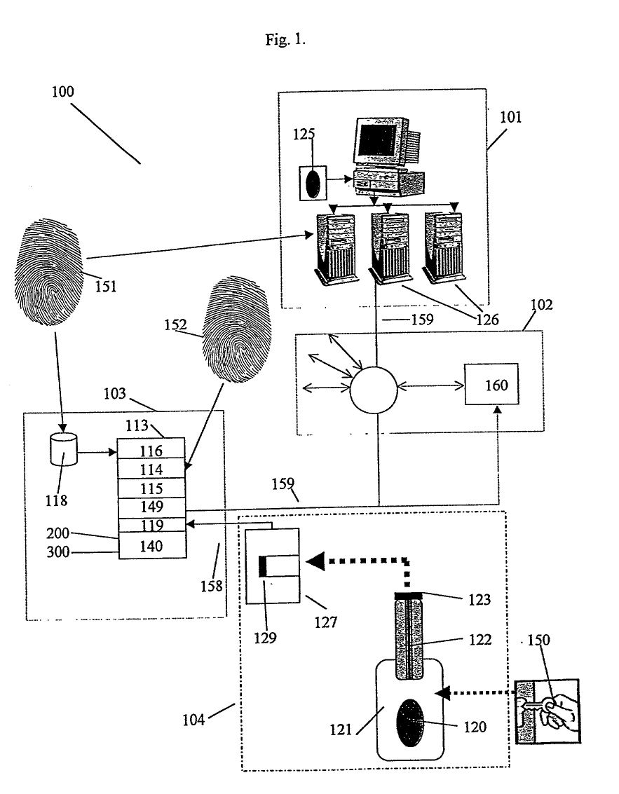

Referring now particularly to FIG. 1, an apparatus 100 for facilitating financial transaction authentication utilizing fingerprint verification includes a client computer 113 having a central processor (CP) 116 well known in the art and commercially available under such trademarks as “Intel® 486”, “Pentium®” and “Motorola 68000”, conventional non-volatile Random Access Memory (RAM) 114, conventional Read Only Memory (ROM) 115, disk storage device 118, and fingerprint sensor interface electronics 119 for communicating digitized fingerprint data therethrough. Central processor 116 is further electrically associated with network electronics interface 149 which enables client computer 113 to communicate over a communications cable 159 or the Internet 160.

An integrated circuit capacitive or electric field-based fingerprint sensor 120, which can be one of many well known to anyone of ordinary skill in the art such as the Veridicom OpenTouch™, Thomson FingerChip™, and AuthenTec Inc. Fingerprint is integrated and embedded in the grip of a key-like device 121. Fingerprint sensor 120 is positioned within the grasp area of key-like device 121 in such a way as to intimately contact the thumb or forefinger of human user 150 as the key is inserted into a receptacle 127. A membrane cable 122, electrically associated with fingerprint sensor 120 and first mating electrical contacts 123, allows digitized fingerprint and control data to be readily communicated to and from the sensor 120 and sensor interface electronics 119 via a serial communications cable 158. A receptacle 127 for receiving key-like device 121 having second mating electrical contacts 129 which mates with said first mating electrical contacts 123 when key 121 is inserted into receptacle 127, is provided as a means to initiate the verification of a human user 150. Electrical contacts 129 are further characterized as being electrically associated with serial communications cable 158. First mating electrical contacts 123 can be arranged along any one of an edge, front or back of key-like device 121 as long as first mating electrical contacts 123 achieve suitable electrical contact with second mating electrical contacts 129 at all times key-like device 121 is inserted into receptacle 127.

The client computer 113 has operably associated therewith fingerprint verification software 140 which compares a first digitized human fingerprint 151, stored on said disk storage device 118 with a second digitized human fingerprint 152 acquired in real-time from human user 150 and provides a signal indicative of verification or non-verification of human user 150. The fingerprint verification software 140 can be of one of several algorithms known by anyone who is of ordinary skill in the art such as minutiae analysis 200 or neural networks 300 or another equivalent algorithm, the particulars of which are further described hereinafter.

An administrative control center 101, for maintaining centralized security databases is comprised of a fingerprint sensor 125 and networked server 126 with display and keyboard, which can be selected from myriad off-the-shelf components known to anyone of ordinary skill in the art, and operably connected to client computer 113 via network communications cable 159, and is provided as means for the enrollment of an authorized first digitized human fingerprint(s) 151 of human user 150. Although the preferred embodiment of the present invention makes use of a conventional keyboard and personal identification code to provide a secure barrier against unauthorized introduction of surreptitious users, the administrative control center 101 may utilize any hardware or software barrier performing the equivalent function. For example, stand-alone fingerprint sensor 125 or a cipher lock may be used in other embodiments. Networked server 126 is preferably located at a position central to the client machines and is connected to the transaction point client machines via network communications cable 159. Alternatively, for the Internet-based embodiment, the connection from the server 126 and the client can be completed via the Internet using one of many secure file transfer protocols which are well known to anyone of ordinary skill in the art.

The network communications cable 159, or the Internet 160, is primarily responsible for transceiving biometric data between network server 126 and client computer 113 and for providing a verification output signal to network server 126. The networked server 126 is configured in such a way that it can permit or prevent completion of a financial transaction based on whether or not human user 150 is verified as properly authorized to access the account associated with said financial transaction.

The secure financial authentication apparatus 100 can make use of minutiae analysis 200, neural networks 300 or another equivalent software algorithm to generate an output signal indicative of verification or non-verification of a human user 150.

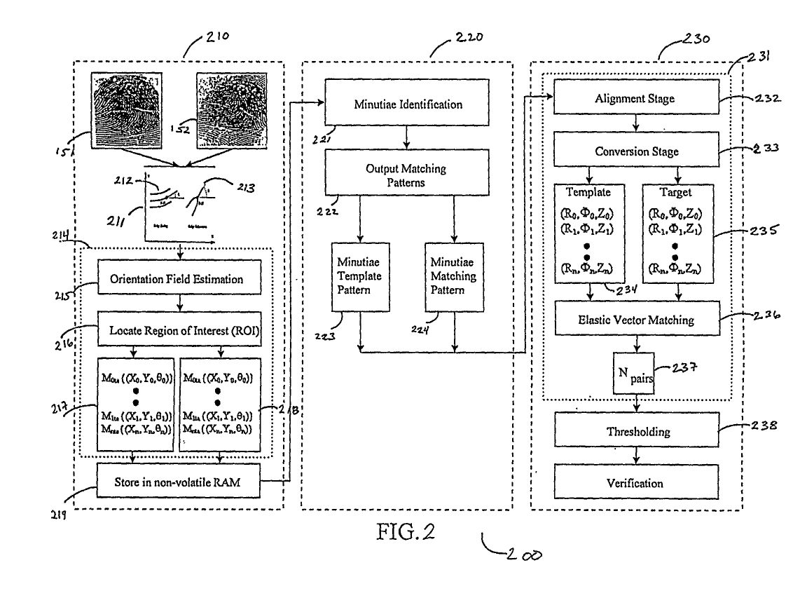

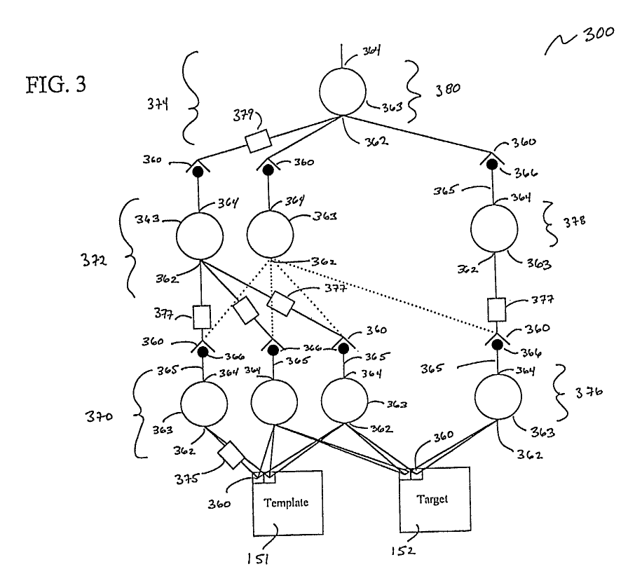

There are a variety of methods by which the identification and verification element of the present invention can be implemented. Although the methods differ in computational structure, it is widely accepted that they are functionally equivalent. Examples of two practical techniques, minutiae analysis 200 and neural network 300, are provided herein below and are depicted in FIG. 2 and FIG. 3 respectively.

As shown in FIG. 2, the minutiae analysis 200, appropriate for implementation of the present invention includes the steps of minutiae detection 210, minutiae extraction 220 and minutia matching 230. First, the fingerprint sensor 125 described in detail herein above, digitizes template fingerprint 151 (stored in the networked server 126 and during the enrollment process described further herein below) and target fingerprint 152 from human user 150 and generates local ridge characteristics 211. The two most prominent local ridge characteristics 211, called minutiae, are ridge ending 212 and ridge bifurcation 213. Additional minutiae suitable for inclusion in minutiae analysis 200 of the present invention exist such as “short ridge”, “enclosure”, and “dot” and may also be utilized by the present invention. A ridge ending 212 is defined as the point where a ridge ends abruptly. A ridge bifurcation 213 is defined as the point where a ridge forks or diverges into branch ridges. A fingerprint 151, 152 typically contains about 75 to 125 minutiae. The next step in minutiae analysis 200 of the present invention involves identifying and storing the location of the minutiae 212, 213 utilizing a minutiae cataloging algorithm 214. In minutiae cataloging 214, the local ridge characteristics from step 211 undergo an orientation field estimation 215 in which the orientation field of the input local ridge characteristics 211 acquired by fingerprint sensor 125 is estimated and a region of interest 216 is identified. At this time, individual minutiae 212, 213 are located, and an X and Y coordinate vector representing the position of minutiae 212, 213 in two dimensional space as well as an orientation angle θ is identified for template minutiae 217 and target minutiae 218. Each are stored 219 in random access memory (RAM) of networked server 126.

Next, minutiae extraction 220 is performed for each detected minutiae previously stored in step 219 above. Each of the stored minutiae 219 are analyzed by a minutiae identification algorithm 221 to determine if the detected minutiae 219 are one of a ridge ending 212 or ridge bifurcation 213. The matching-pattern vectors which are used for alignment in the minutiae matching 230 step, are represented as two-dimensional discrete signals which are normalized by the average inter-ridge distance. A matching-pattern generator 222 is employed to produce standardized vector patterns for comparison. The net result of the matching-pattern generator 222 are minutiae matching patterns 223 and 224. With respect to providing verification of a fingerprint as required by the present invention, minutiae template pattern 223 is produced for the enrolled fingerprint 151 of human user 150 and minutiae target pattern 224 is produced for the real-time fingerprint 152 of human user 150.

Subsequent minutiae extraction 220, the minutiae matching 230 algorithm determines whether or not two minutiae matching patterns 223, 224 are from the same finger of said human user 150. A similarity metric between two minutiae matching patterns 223, 224 is defined and a thresholding 238 on the similarity value is performed. By representing minutiae matching patterns 223, 224 as two-dimensional “elastic” point patterns, the minutiae matching 230 may be accomplished by “elastic” point pattern matching, as is understood by anyone of ordinary skill in the art, as long as it can automatically establish minutiae correspondences in the presence of translation, rotation and deformations, and detect spurious minutiae and missing minutiae. An alignment-based “elastic” vector matching algorithm 231 which is capable of finding the correspondences between minutiae without resorting to an exhaustive search is utilized to compare minutiae template pattern 223, with minutiae target pattern 224. The alignment-based “elastic” matching algorithm 231 decomposes the minutiae matching into three stages: (1) An alignment stage 232, where transformations such as translation, rotation and scaling between a template pattern 223 and target pattern 224 are estimated and the target pattern 224 is aligned with the template pattern 223 according to the estimated parameters; (2) A conversion stage 233, where both the template pattern 223 and the target pattern 224 are converted to vectors 234 and 235 respectively in the polar coordinate system; and (3) An “elastic” vector matching algorithm 236 is utilized to match the resulting vectors 234, 235 wherein the normalized number of corresponding minutiae pairs 237 is reported. Upon completion of the alignment-based “elastic” matching 231, a thresholding 238 is thereafter accomplished. In the event the number of corresponding minutiae pairs 237 is less than the threshold 238, a signal indicative of non-verification is generated by client computer 113. Conversely, in the event the number of corresponding minutiae pairs 237 is greater than the threshold 238, a signal indicative of verification is generated by client computer 113. Either signal is communicated by client computer 113 to networked server 126 via communication cable 159 as described in detail herein above.

Referring now particularly to FIG. 3, and according to a second preferred embodiment, an exemplary neural network 300 of the present invention includes at least one layer of trained neuron-like units, and preferably at least three layers. The neural network 300 includes input layer 370, hidden layer 372, and output layer 374. Each of the input layer 370, hidden layer 372, and output layer 374 include a plurality of trained neuron-like units 376, 378 and 380, respectively.

Neuron-Eke units 376 can be in the form of software or hardware. The neuron-like units 376 of the input layer 370 include a receiving channel for receiving digitized human fingerprint data 151, and stored comparison fingerprint data 152 wherein the receiving channel includes a predetermined modulator 375 for modulating the signal.

The neuron-like units 378 of the hidden layer 372 are individually receptively connected to each of the units 376 of the input layer 370. Each connection includes a predetermined modulator 377 for modulating each connection between the input layer 370 and the hidden layer 372.

The neuron-like units 380 of the output layer 374 are individually receptively connected to each of the units 378 of the hidden layer 372. Each connection includes a predetermined modulator 379 for modulating each connection between the hidden layer 372 and the output layer 374. Each unit 380 of said output layer 374 includes an outgoing channel for transmitting the output signal.

Each neuron-like unit 376, 378, 380 includes a dendrite-like unit 360, and preferably several, for receiving incoming signals. Each dendrite-like unit 360 includes a particular modulator 375, 377, 379 which modulates the amount of weight which is to be given to the particular characteristic sensed as described below. In the dendrite-like unit 360, the modulator 375, 377, 379 modulates the incoming signal and subsequently transmits a modified signal 362. For software, the dendrite-like unit 360 comprises an input variable Xₐ and a weight value Wₐ wherein the connection strength is modified by multiplying the variables together. For hardware, the dendrite-like unit 360 can be a wire, optical or electrical transducer having a chemically, optically or electrically modified resistor therein.

Each neuron-like unit 376, 378, 380 includes a soma-like unit 363 which has a threshold barrier defined therein for the particular characteristic sensed. When the soma-like unit 363 receives the modified signal 362, this signal must overcome the threshold barrier whereupon a resulting signal is formed. The soma-like unit 363 combines all resulting signals 362 and equates the combination to an output signal 364 indicative of one of a recognition or non-recognition of a human user 150.

For software, the soma-like unit 363 is represented by the sum α=Σₐ XₐWₐ−β, where β is the threshold barrier. This sum is employed in a Nonlinear Transfer Function (NTF) as defined below. For hardware, the soma-like unit 363 includes a wire having a resistor; the wires terminating in a common point which feeds into an operational amplifier having a nonlinear component which can be a semiconductor, diode, or transistor.

The neuron-like unit 376, 378, 380 includes an axon-like unit 365 through which the output signal travels, and also includes at least one bouton-like unit 366, and preferably several, which receive the output signal from the axon-like unit 365. Bouton/dendrite linkages connect the input layer 370 to the hidden layer 372 and the hidden layer 372 to the output layer 374. For software, the axon-like unit 365 is a variable which is set equal to the value obtained through the NTF and the bouton-like unit 366 is a function which assigns such value to a dendrite-like unit 360 of the adjacent layer. For hardware, the axon-like unit 365 and bouton-like unit 366 can be a wire, an optical or electrical transmitter.

The modulators 375, 377, 379 which interconnect each of the layers of neurons 370, 372, 374 to their respective inputs determines the classification paradigm to be employed by the neural network 300. Digitized human fingerprint data 152, and stored comparison fingerprint data 151 are provided as discrete inputs to the neural network and the neural network then compares and generates an output signal in response thereto which is one of recognition or non-recognition of the human user 150.

It is not exactly understood what weight is to be given to characteristics which are modified by the modulators of the neural network, as these modulators are derived through a training process defined below.

The training process is the initial process which the neural network must undergo in order to obtain and assign appropriate weight values for each modulator. Initialy, the modulators 375, 377, 379 and the threshold barrier are assigned small random non-zero values. The modulators can each be assigned the same value but the neural network's learning rate is best maximized if random values are chosen. Digital human fingerprint data 151 and stored comparison fingerprint data 152 are fed in parallel into the dendrite-like units of the input layer (one dendrite connecting to each pixel in fingerprint data 151 and 152) and the output observed.

The Nonlinear Transfer Function (NTF) employs a in the following equation to arrive at the output:

NTF=1/[1+e^{-α}]

For example, in order to determine the amount weight to be given to each modulator for any given human fingerprint, the NTF is employed as follows:

If the NTF approaches 1, the soma-like unit produces an output signal indicating recognition. If the NTF approaches 0, the soma-like unit produces an output signal indicating non-recognition.

If the output signal clearly conflicts with the known empirical output signal, an error occurs. The weight values of each modulator are adjusted using the following formulas so that the input data produces the desired empirical output signal.

For the output layer:

W*ₖₒₗ=Wₖₒₗ+GEₖZₖₒₛ

W*ₖₒₗ=new weight value for neuron-like unit k of the outer layer.

W*ₖₒₗ=current weight value for neuron-like unit k of the outer layer.

G=gain factor

Zₖₒₛ=actual output signal of neuron-like unit k of output layer.

Dₖₒₛ=desired output signal of neuron-like unit k of output layer.

Eₖ=Zₖₒₛ(1−Zₖₒₛ)(Dₗₒₛ−Zₖₒₛ), (this is an error term corresponding to neuron-like unit k of outer layer).

For the hidden layer:

W*ⱼₕₗ=Wⱼₕₗ+GEⱼYⱼₒₛ

W*ⱼₕₗ=new weight value for neuron-like unit j of the hidden layer.

Wⱼₕₗ=current weight value for neuron-like unit j of the hidden layer.

G=gain actor

Yⱼₒₛ=actual output signal of neuron-like unit j of hidden layer.

Eⱼ=Yⱼₒₛ(−1−Yⱼₒₛ)Σₖ(Eₖ*Wₖₒₗ), (this is an error term corresponding to neuron-like unitj of hidden layer over all k units).

For the input layer:

W*ᵢᵢₗ=Wᵢᵢₗ+GEᵢXᵢₒₛ

W*ᵢᵢₗ=new weight value for neuron-like unit I of input layer.

Wᵢᵢₗ=current weight value for neuron-like unit I of input layer.

G=gain factor

Xᵢₒₛ=actual output signal of neuron-like unit I of input layer.

Eᵢ=Xᵢₒₛ(1−Xᵢₒₛ)Σⱼ(Eⱼ*Wⱼₕₗ)(this is an error term corresponding to neuron-like unit i of input layer over all j units).

The training process consists of entering new (or the same) exemplar data into neural network 300 and observing the output signal with respect to a known empirical output signal. If the output is in error with what the known empirical output signal should be, the weights are adjusted in the manner described above. This iterative process is repeated until the output signals are substantially in accordance with the desired (empirical) output signal, then the weight of the modulators are fixed.

Upon fixing the weights of the modulators, predetermined fingerprint-space memory indicative of recognition and non-recognition are established. The neural network 300 is then trained and can make generalized comparisons of human fingerprint input data by projecting said input data into fingerprint-space memory which most closely corresponds to that data.

The description provided for neural network 300 as utilized in the present invention 100 is but one technique by which a neural network algorithm can be employed. It will be readily apparent to those who are of ordinary skill in the art that numerous neural network paradigms including multiple (sub-optimized) networks as well as numerous training techniques can be employed to obtain equivalent results to the method as described herein above.

The preferred method of securing financial transactions, of the present invention begins with the human user 150, enrolling an authorized fingerprint(s) from one or more fingers to be utilized as a template(s) for all subsequent verifications. To accomplish this, the human user 150 with the assistance of a human administrator touches fingerprint sensor 125 associated with networked server 126 of the administrative control center 101 which subsequently stores the fingerprint 151 in non-volatile RAM. This process is repeated from one to four times to ensure a good first fingerprint 151 is acquired for each of said human users 150. These first human fingerprints are processed, the highest quality fingerprint(s) selected and thenceforth encoded and stored locally on an internal fixed storage device of networked server 126. The remaining first human fingerprint(s) will be utilized thereafter as an authorized template fingerprint 151. The above described process can be repeated if the user wishes to enroll additional fingerprints from other fingers on the user's hand. This enrollment step would typically take place at the time the user applies for a financial account with a financial institution. For example, if the user opens a banking account that employs an ATM which uses the biometric key of the present invention, the user would be given the key and enrolled in the system at the time the user's account is opened. The enrollment takes place at a centralized network server which is further interconnected to each of the client ATM machines through a communications network. Thus, at a later time when the user attempts to access the account during a financial transaction, the biometric identification information will be transceived from the central sever to the local client at the time of verification. Similarly, the Internet, which generally embodies a server-client relationship, can be utilized as the communications network through which biomteric information is transceived during Internet-based financial transactions. In this example, the user would enroll at the time the Internet-based account was established. This enrollment, unlike the ATM example detailed herein above, can take place at the local client machine with biometric information being transmitted from the client to the central server where it is thereupon processed and stored as described previously.

As generally described herein above, when authentication of a financial transaction is required, authorization information regarding human user 150 and authorized template fingerprint 151 data is communicated to client computer 113 via the network communication cable 159 or Internet 160 whereupon it is stored in local RAM memory 114. The client computer 113 subsequently acquires several digitized second human fingerprints 152 of the human user 150 through the use of fingerprint sensor 120 embedded in key-like device 121.

With respect to preventing fraudulent financial transactions and more particularly preventing fraud in ATM, credit/debit card, telephone calling card and Internet-based financial transactions of the present invention, a human user 150 triggers a verification event automatically prior to commencing the financial transaction. With respect to an ATM, the human user 150 inserts key-like device 121 into receptacle 127. When key 121 is inserted into receptacle 127, electrical contacts 123 mate with electrical contacts 129 enabling the passing of electronic signals therethrough. At this time, fingerprint sensor 120 is proximate the thumb or forefinger of human user 150, whereupon fingerprint sensor 120 begins acquiring second human fingerprints of the human user 150 and converts said second human fingerprints to digital data. The digitized second human fingerprints obtained thereafter are stored in the non-volatile RAM memory 114 of client computer 113 as target fingerprint(s) 152.

Once the said target fingerprint(s) 152 has been stored in the client computer 113, the verification software 140, either minutiae analysis 200 or neural network 300 or another suitable algorithm, as described in detail herein above, is employed to perform a comparison between said stored template fingerprint(s) 151 and said stored target fingerprint(s) 152 and produce an output signal in response thereto indicative of recognition or non-recognition of the human user 150. The output signal is therewith provided to the networked server 126 via communications cable 159. Once the networked server 126 has received confirmation either of recognition or non-recognition of human user 150, it can permit or prevent the financial transaction. In the event the said target fingerprint(s) 152 of human user 150 is verified, the networked server 126 would permit the financial transaction to take place. In the event the said target fingerprint(s) 152 of human user 150 is not verified, the networked server 126 would not allow the completion of the financial transaction. In addition, in the event target fingerprint(s) 152 of human user 150 is not verified, the networked server 126 can optionally trigger an alarm system to notify a guard or other individual responsible for financial transaction security.

Similarly, credit/debit card, telephone calling card and Internet-based financial transactions will require the human user 150 to initiate a biometric verification by inserting the key-like device 121 into a receptacle 127. As described above in detail with respect to the ATM application, after triggering a verification event, biometric information pertaining to the authorized account holder that is stored on networked server 126 will be transmitted to the client computer 113, which in the case of an Internet-based transaction would likely consist of a personal computer. Subsequent this transmission client computer 113 utilizing the verification steps outlined in detail herein above will produce a signal indicative of verification or non-verification of human user 150 and transmit this information back to the networked server 126 via the communications cable 159 or the Internet 160, also as described in detail herein above. In this way, any type of financial transaction can be protected by the distributed networked biometric system of the present invention.

The above described embodiments are set forth by way of example and are not for the purpose of limiting the scope of the present invention. It will be readily apparent to those or ordinary skill in the art that obvious modifications, derivations and variations can be made to the embodiments without departing from the scope of the invention. For example, the fingerprint verification algorithms described above as either a minutiae analysis 200 or neural network 300 could also be one of a statistical based system, template or pattern matching, or even rudimentary feature matching whereby the features of the fingerprints are analyzed. Accordingly, the claims appended hereto should be read in their full scope including any such modifications, derivations and variations.

What is claimed is:

1. A key system for authenticating financial transactions, comprising:
a key-like device;
a receiver for receiving said key-like device;
a biometric sensor integrally associated with said key-like device; and
a processor associated with said receiver, said processor being capable of processing signals from said biometric sensor in a manner such that the identity of a person using said key-like device is verified.

2. The key system of claim 1, further comprising mating electrical contacts for connecting said biometric sensor to said processor.

3. The key system of claim 2, wherein said biometric sensor includes a fingerprint sensor for acquiring a digitized fingerprint of said person when said person holds said key-like device.

4. The key system of claim 3, further comprising software resident on said processor for identifying said person and providing an output signal indicative of recognition for use in authenticating financial transactions.

5. The key system of claim 4, wherein said financial transactions are further characterized to include an ATM machine.

6. The key system of claim 4, wherein said financial transactions are further characterized to include telephone calling cards.

7. The key system of claim 4, wherein said financial transactions are further characterized to include credit and debit card transactions.

8. The key system of claim 4, wherein said financial transactions are further characterized to include transactions made through the Internet.

9. The key system of claim 4, wherein said key-like device is further characterized to be incorporated in a standard-sized magnetic-stripe card.

10. A financial authentication system comprising:
a receiver for receiving a key-like device with an integral fingerprint sensor;
a processor associated with the fingerprint sensor and capable of manipulating signals therefrom;
mating electrical contacts for connecting said fingerprint sensor to said processor;
software resident on said processor for identifying a human user and providing an output signal indicative of recognition for use in authenticating financial transactions.

11. The financial authentication system of claim 10, further comprising software resident on said processor for detecting fraudulent financial transactions.

12. A method for authenticating financial transactions, including the steps of:
enrolling a first digitized fingerprint of an authorized human user and storing said first digitized fingerprint in the memory element of a processor;
detecting when said human user attempts to authenticate a financial transaction and acquiring a second digitized fingerprint;
comparing said first and second digitized fingerprints to determine a match confidence;
authorizing or rejecting said financial transaction in the event the match confidence falls above or below a predetermined threshold.

13. The method of claim 12, which is further characterized to include the step of detecting a fraudulent financial transaction in the event the match confidence falls below a predetermined threshold.

14. The method of claim 13 which is further characterized to include the step of notifying a security monitoring service in the event a fraudulent financial transaction is detected.
